(19) United States
(12) Patent Application Publication
(10) Pub. No.: US 2006/0176147 A1
(43) Pub. Date: Aug. 10, 2006

(54) Vehicle security system

(75) Inventors: Andreas Pohlmann, Weil der Stadt (DE); Markus Ruther, Ostfildem (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/539,596

(22) PCT Filed: Nov. 11, 2003
(86) PCT No.: PCT/EP03/12575

§ 371 Date: Mar. 14, 2006

(30) Foreign Application Priority Data
Dec. 19, 2002 (DE) 102 59 590.9

(51) Int. Cl. B60R 25/00

(52) U.S. Cl. 340/5.61; 340/5.72; 340/426.36

(57) ABSTRACT

The invention relates to a vehicle security system in the form of a keyless-go system and an operating method for it. In the vehicle security system, incorrect detection of a position of an authentication element (1) inside or outside the vehicle by authentication element locating means (21) in a vehicle-mounted access control component owing to at least one interference transmitter (10) which is present in the surroundings of the vehicle and/or of the authentication element (1) is avoided by using a device for performing empty measurement (9) in the authentication element (1). To do this, the device for performing empty measurement (9) performs a measurement in time periods in which the vehicle-mounted access control component (2) does not emit any pulses to the authentication element (1), by means of which measurement the interference level caused by the at least one interference transmitter (10) is determined. Depending on whether this determined interference level exceeds or drops below a predetermined threshold value, either the device for performing empty measurement (9) transmits, to the vehicle-mounted access control component (2), an adapted threshold value for a decision as to whether an authentication element (1) is located in the vehicle or outside the vehicle, or said device does not respond to subsequent pulses from the vehicle-mounted access control component (2).

### BACKGROUND AND SUMMARY OF THE INVENTION

This application claims the priority of German patent document no. 102 59 590.9, filed Dec. 19, 2002 (PCT International Application No. PCT/EP2003/012575, filed Nov. 11, 2003), the disclosure of which is expressly incorporated by reference herein.

The vehicle relates to a vehicle security system and a method for operating such a system.

In vehicle security systems in the form of what are referred to as keyless or “keyless-go” systems, authentication (i.e., checking of authorization) is carried out using portable, action-free authentication elements in the action range of a wireless communications channel. Action range is understood here to be the range within which the authentication element must be located for a triggered access authentication checking process to be carried out successfully.

German patent document DE 44 09 167 C1 discloses such a keyless-go system which uses a distance detection device that operates, for example, on the basis of UHF or ultrasonic signals or in the manner of a metal detector, and measures the distance between an authentication element and the associated vehicle. After the reception of an interrogation code signal which is emitted by a vehicle mounted transmitter unit when a triggering means is actuated, the authentication element emits a response code signal only if the distance detection device determines that the distance between the authentication element and the vehicle is not greater than a predefinable maximum distance.

Furthermore, German patent document DE 195 42 441 C2 discloses various vehicle-mounted antenna units of access authorization communications channels and/or driving authorization communications channels for vehicle security systems with action-free authentication elements in the form of portable transponders which can be carried by a person, with possible positioning processes of the antennas and their resulting action range being specified. Depending on which antenna or antennas emit(s) an interrogation code signal and which antenna receives a response code signal from the transponder with what intensity, it is possible to locate the transponder and where necessary also follow it as it moves.

Finally, German patent document DE 198 39 355 C1 discloses a vehicle security system having an access control device. The access control device comprises one or more action-free authentication elements which can be carried by a user, a vehicle-mounted access control component, a wireless access authorization communications channel for access-authorization-checking processes and a triggering element which can be addressed by a user in order to request the generation of a securing or releasing access control signal for at least one vehicle lock element. The access control component triggers an access-authorization-checking process in response to such a request, and that process is carried out successfully only if the respective authentication element is located within the predefined action range of the communications channel. In addition, authentication element locating means are provided for determining whether an authentication element is located on the outside of a vehicle in the action range of the communications channel when an access-authorization-checking communications process is triggered. At least some of the possible securing or releasing access control signals are then generated as a function of whether a valid authentication element is determined on the outside of the vehicle.

In such conventional keyless-go systems, in order to locate an authentication element (for example a key, chip card or the like), pulses are transmitted via different antennas from the vehicle to the authentication element and back. Such pulses may have different frequencies and different forms. By means of these pulses the authentication element or an authentication element locating means in the vehicle determines its position at the vehicle. However, if there are interference transmitters present, which transmit in the same frequency range, the position of the authentication element at the vehicle/with respect to the vehicle may be evaluated incorrectly. For example, the authentication element could be located outside the vehicle but as a result of the interference transmitter a field strength is present which indicates that the authentication element must be located within the vehicle. This may result in malfunctions, in particular as a result of the incorrect evaluation as to whether the authentication element is inside or outside the vehicle. For example, locking may not be possible even though the authentication element is located outside the vehicle but as a result of the interference signal the authentication element is evaluated as being located inside the vehicle.

One object of the present invention is to provide a method and apparatus of the generic type for determining the position of a key of a keyless-go system in such a way that the position of the authentication element can be reliably determined at the vehicle, even in the presence of interference transmitters.

This and other objects and advantages are achieved by the security method and apparatus according to the invention in which a device for performing a null measurement of field strength is provided in the authentication element. The null measurement device measures field strength during null time periods in which the vehicle-mounted access control component (2) does not emit any pulses to the authentication element (1), thereby providing a measurement of the interference level caused by the at least one interference transmitter. Depending on whether or not the determined interference level exceeds a predetermined threshold value, the device for performing the null measurement either transmits to the vehicle-mounted access control component an adapted threshold value for a decision as to whether an authentication element is located in the vehicle or outside the vehicle, or does not respond to subsequent pulses from the vehicle-mounted access control component.

In this way it is possible to improve the process of locating the authentication element. That is, incorrect interpretation of the location of the authentication element is prevented, even when an interference transmitter is present, so that the distinction between the inside and outside regions of the vehicle becomes more precise. Malfunctions as a result of an incorrect interpretation of the position of the authentication element can thus be reliably prevented.

Other objects, advantages and novel features of the present invention will become apparent from the following detailed description of the invention when considered in conjunction with the accompanying drawings.

### BRIEF DESCRIPTION OF THE DRAWINGS

FIG. 1 is a block circuit diagram of a vehicle security system according to the invention;

FIG. 2 is a flowchart that illustrates the function of the vehicle security system according to FIG. 1; and

FIG. 3 is an illustration of an exemplary signal profile during the inventive determination of an interference field strength by means of null measurement.

### DETAILED DESCRIPTION OF THE DRAWINGS

In a keyless-go system which is used in a vehicle security system for the purpose of locating an authentication element (for example a key or a code card or chip card), pulses are generally transmitted via different antennas, from the vehicle to the authentication element and back. The pulses may have different frequencies and shapes. By means of these pulses the authentication element determines the location of the authentication element at/with respect to the vehicle. Alternatively this may be done by an authentication element locating means in the vehicle.

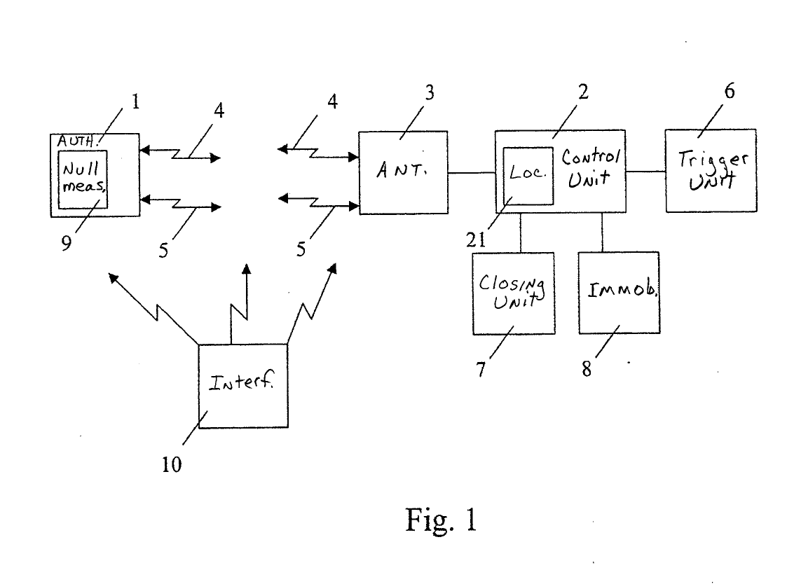

The vehicle security system which is illustrated schematically in FIG. 1 contains an access control device and an electronic immobilizer and is embodied as a keyless-go system. That is, one or more action-free authentication elements which can be carried by the operator (one of which is depicted in FIG. 1), are used by the operator to prove his authorization to enter the vehicle and start it. An independent code card or chip card, for example, may be used as the authentication element. Alternatively, a chip card or a functionally equivalent authentication element may be integrated into a mechanical or electronic key, if the intention is that the user will be enabled optionally also to enter or to lock the vehicle and/or to start the engine or shut it down in a customary fashion by means of such a key system. Other conventional types of authentication elements can also be used.

The vehicle security system contains a control unit 2 situated at the vehicle, which is common to an access control device and an electronic immobilizer. (Alternatively, it is also possible to provide separate control units.) An antenna unit 3 with a plurality of suitably configured antennas that are positioned at the vehicle is connected to the control unit 2. The control unit 2 communicates with the respective authentication element 1 via the antennas in order to carry out authentication processes. This communication is carried out for communications processes which relate to vehicle access by means of a wireless access authorization communications channel 4 and for communications processes which relate to the electronic immobilizer by means of a driving authorization communications channel 5. The two communications channels 4, 5 are preferably combined to form one common communications channel. In all cases, the authentication element 1 is configured in such a way that it is capable of communicating with the control unit 2 to test both the access authorization and the driving authorization, which may entail respective identical authentication processes when there is a common communications channel. The communications channel or channels may be, for example, a frequency band around 433 MHz, also around 315 MHz for the USA, or alternatively around 125 kHz. The frequency band in the case of 433 MHz permits typical ranges in the region from approximately 1 km to approximately 30 m to be implemented cost-effectively. When the frequency band around 125 kHz is used, the range can be comparatively satisfactorily set by means of the exponentially dropping magnetic field.

The authentication element 1 communicates bidirectionally with the vehicle-mounted system component over the communications channels 4, 5. Preferably, it is embodied without batteries, drawing the required transmission energy from the field radiated by the vehicle-mounted antenna unit 3. In applications in which this field which is radiated at the vehicle end is too weak to supply energy to the authentication element 1, even at a distance of approximately 1 m, the authentication elements 1 are equipped with batteries in order to achieve a sufficiently large range. When the battery is null the authentication element 1 can then be moved sufficiently close to the vehicle and thus be supplied with external energy.

Furthermore, a triggering unit connected to the control unit 2, and 6 comprises a plurality of suitable triggering elements which can be addressed by the user and with which the user can request a desired control measure of the access control device or of the electronic immobilizer. In response to such a request, the control unit 2 first triggers an authentication process with which the authorization of the requesting user is checked. In order to carry out this authentication process successfully it is necessary for at least one authentication element 1 which provides authorization for this vehicle to be located within the action range of the communications channel or channels 4, 5 (i.e., within the action range or capture range of one or more antennas of the antenna unit 3). For this purpose it is sufficient in the case of a keyless-go system for the user to carry the authentication element 1 on his person. The action range of the access authorization communications channel 4 and that of the driving authorization communications channel 5 are respectively suitably selected for this purpose, in particular by suitable shaping and arrangement of the various antennas of the antenna unit 3.

The control unit 2 actuates both a closing unit 7 with a plurality of vehicle lock elements, in particular in each case a lock element for the vehicle doors and for a tailgate, and also an immobilizer unit 8 which contains, in a conventional way, suitable actuating elements for releasing or blocking an engine start, such as corresponding, actuatable switching elements for switching the ignition on and off and/or for starting the engine. Depending on whether a control measure for the access control device or the electronic immobilizer has been requested by the user by means of the triggering unit 6, the control unit 2 actuates the lock unit 7 or the immobilizer unit 8 as desired when the authentication process proceeds successfully. The lock unit 7 may be formed here in particular by a conventional central locking system which is switched by the securing or releasing access control signal of the control unit 2 into its locked or released state. Furthermore, it is possible to provide for the lock element for the tailgate to be actuatable separately in order to be able to open it without releasing the vehicle doors.

Furthermore, authentication element locating means 21 (implemented by means of hardware or software) are provided in the control unit 2, and can be used to determine whether, when an access-authorization-checking communications process is triggered, an authorizing authentication element 1 is located outside of the vehicle in the action range of the access authorization communications channel 4. Here, the precise implementation of these authentication locating means 12 depends on the position of the action range of the access authorization communications channel 4, which action range corresponds to the combination of the action ranges of all the associated individual antennas, in particular on whether or not this action range also extends significantly into the inside of the vehicle, as explained below. The control unit 2 also performs the control measure which is requested by the user, and relates to the vehicle access as a function of whether the authentication element locating means 21 have determined that an authorizing authentication element 1 which is located in the action range of the access authorization communications channel 4 and therefore results in a successful authentication process is located on the outside of the vehicle (and not, for example, in the interior of the vehicle). For this purpose, a field strength of the signal in response to the access authorization communications channel 4 is determined and when a specific threshold value is exceeded the authentication element 1 is assessed as being located in the interior of the vehicle, i.e., the passenger compartment or trunk.

In order to prevent incorrect assessment of the position of the authentication element 1, (that is, whether it is in the interior of the vehicle or outside of the vehicle) by interference transmitters 6 (as a result of which opening takes place incorrectly or locking is incorrectly prevented), according to the invention a device for performing a null measurement 9 (also shown in FIG. 1) is additionally embodied in the authentication element 1.

In the exemplary embodiment according to the invention, the device for performing null measurement 9 is designed to prevent incorrect assessments of the position of the authentication element 1 with respect to the vehicle due to a field strength which is generated by an interference transmitter or transmitters in the same frequency range. The device for performing null measurement 9 measures an applied field strength at the useful frequency of the authentication element 1 at a time during which the vehicle does not emit any field (i.e., a signal is not transmitted from the vehicle on the access authorization communications channel 4). The field strength measured at this time corresponds to an interference field strength which is generated by one or more interference transmitters which happen to be present (i.e., to an interference level which has an adverse effect on the communication between the authentication element 1 and the vehicle on the access authorization communications channel 4). The interference field strength which is measured by the device for performing null measurement 9 is subsequently used to evaluate the field strength of pulses from the vehicle which is measured in the “normal operating mode” and by means of which the position of the authentication element 1 with respect to the vehicle is determined. Depending on the magnitude of the interference field strength determined by the device for performing null measurement 9, the decision threshold value for distinguishing whether an authentication element 1 is located outside of the vehicle or in its interior (in the case of low or medium-sized interference field strengths) is adapted to a level at which an unambiguous detection is still possible. This adapted decision threshold value is transmitted to the control unit with the authentication element locating means 21. In the case of high to very high interference field strengths, the field strengths which are determined during subsequent communication and subject to such interference are rejected so that when an interrogation signal is subsequently received from the vehicle, no response signal is transmitted on the access authorization communications channel 4.

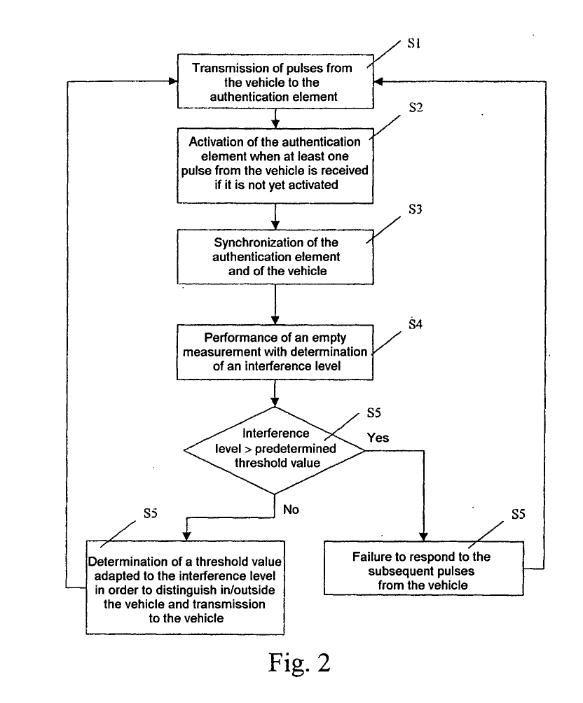

The function of the vehicle security system according to the invention which is shown in FIG. 1 will be explained further below with reference to the flowchart in FIG. 2. In the keyless-go system contained in the vehicle security system, the control unit 2 emits pulses, which are intended for the authentication element 1 of the keyless-go system (step S1), over the access authorization communications channel 4 by means of the antenna unit 3 with various antennas arranged at various positions at the vehicle or in the vehicle. As soon as the authentication element 1 of the keyless-go system is located in the range of these pulses, the authentication element 1 is “awakened” (i.e., activated) in step S2. After the activation, synchronization is carried out between the authentication element 1 and the vehicle in step S3 in response to such a pulse from the vehicle. On the basis of this synchronization a device for performing null measurement of the authentication element 1 knows the predetermined intervals at which the vehicle will emit further pulses.

After the synchronization, the device for performing null measurement 9 carries out a null measurement in step S4. That is, it measures the interference level of one or more interference transmitters which happen to be present, in the same frequency range, but during a time period or at a time in which the vehicle does not emit any pulses. Based on the determined interference level, (i.e., the determined interference field strength), either i) a signal from the vehicle to the authentication element 1 which is measured directly before or after is rejected in step S5 as a function of the determined level of the interference field strength if a predetermined threshold value for the interference level or the interference field strength is exceeded (since then reliable detection is then no longer possible), i.e., a response signal is not transmitted to the control unit 2 over the access authorization communications channel 4 by means of the authentication element locating means 21 in the vehicle, or ii) a new threshold value, adapted to the interference field strength, for distinguishing between an authentication element 1 in the vehicle or on the outside of the vehicle is determined by the device for performing null measurement and is transmitted over the access authorization communications channel 4 to the control unit 2 by means of the authentication element locating means 21 so that it can be taken into account during subsequent position-determining processes. If a response signal is not transmitted to the vehicle due to an excessively large interference level, correct detection may not be possible until the authentication element 1 is located nearer to the vehicle, and if not in such a case it is necessary to have recourse to a conventional key. However, this ensures fault-free functioning of the vehicle security system so that no unintentional locking or release processes occur.

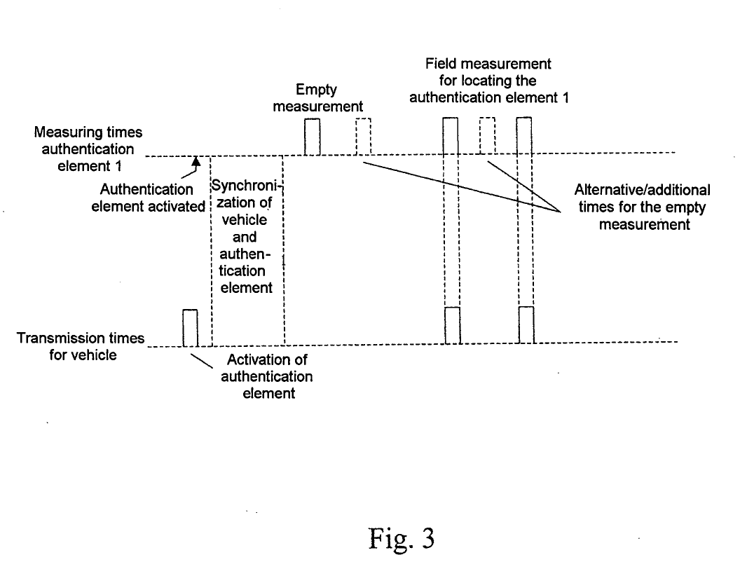

Finally, FIG. 3 shows, by way of example, both the transmission signal profile of the pulses from the vehicle and the transmission signal profile of the authentication element 1 including the null measurements. In this illustration, possible alternative or additional times for null measurements are illustrated by dashed lines. It is generally to be noted that a null measurement can be carried out at any time in the transmission protocol only as long as it is ensured that the vehicle does not emit any pulses at this time, so that only one interference level is sensed.

To summarize, the invention relates to a keyless-go vehicle security system, and to a method for operating such a system. In the vehicle security system, incorrect detection of a position of an authentication element 1 (inside or outside the vehicle) by authentication element locating means 21 in a vehicle-mounted access control component due to one or more interference transmitters which may be present in the surroundings of the vehicle and/or of the authentication element 1 is avoided by using a device for performing null measurement 9 in the authentication element 1. For this purpose, the device for performing null measurement 9 performs a measurement in time periods in which the vehicle-mounted access control component 2 does not emit any pulses to the authentication element 1. By means of this measurement, the interference level caused by the at least one interference transmitter 10 is determined. Depending on whether or not the determined interference level exceeds or drops below a predetermined threshold value, either i) the device for performing null measurement 9 transmits to the vehicle-mounted access control component 2 an adapted threshold value for a decision as to whether an authentication element 1 is located inside or outside the vehicle, or ii) said device does not respond to subsequent pulse from the vehicle-mounted access control component 2.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-6. (canceled)

7. A vehicle security system comprising:
an access control device having at least one action-free authentication element which can be carried by a vehicle user;
a vehicle-mounted access control component;
a wireless access authorization communications channel for access-authorization-checking communication between the at least one authentication element and the access control component, wherein the access control component generates a securing or releasing access control signal for at least one vehicle lock element only when there is a positive access-authorization-checking result;
at least one triggering element, which can be actuated by the user to request the generation of a respective securing or releasing access control signal, whereby a respective access-authorization-checking communications process is triggered and said process is carried out successfully only if an authorizing authentication element is in the predefined action range of the access authorization communications channel; and
authentication element location means for determining whether, when an access-authorization-checking communication process is triggered, an authorizing authentication element is located outside of the vehicle in the action range of the access authorization communications channel and not in the interior of the vehicle or on the outside of the vehicle outside the action range of the access authorization communications channel; wherein
the vehicle-mounted access control component generates at least some of the possible access control signals for the at least one vehicle lock element as a function of whether the authentication element locating means determines the presence of an authorizing authentication element on the outside of the vehicle in the action range of the access authorization communications channel and not in the interior of the vehicle or on the outside of the vehicle outside the action range of the access authorization communications channel;
a device for carrying out a null measurement senses an applied field strength at a time when the vehicle does not emit a signal in response to the access authorization communications signal;
said device determines an interference level based on said null measurement;
by taking into account the determined interference level, said device either i) transmits an adapted decision threshold value for distinguishing the position of the authentication element to the authentication element locating means, or ii) rejects subsequent interrogation signals from the access control component.

8. The vehicle security system as claimed in claim 7, wherein:
when there is an interference level that is below a predetermined threshold value, the device for performing null measurement transmits the adapted decision threshold value for distinguishing the position of the authentication element to the authentication element locating means;
when there is an interference level above the predetermined threshold value it rejects subsequent interrogation signals from the access control component.

9. The vehicle security system as claimed in claim 8, wherein the device for performing a null measurement is embodied in the authentication element.

10. The vehicle security system as claimed in claim 9, wherein:
for synchronizing authentication element with the vehicle, the device is provided with information about the time at which the vehicle emits pulses; and
said device performs the null measurement at times between the pulses.

11. The vehicle security system as claimed in claim 10, wherein the authentication element is activated in response to a reception of pulses from the vehicle.

12. A method for operating a vehicle security system, having the steps:
pulses which are intended for an action-free authentication element that can be carried by a user are transmitted by a vehicle-mounted access control component over a wireless access authorization communications channel by means of an antenna unit;
the authentication element is activated when pulses are received by the vehicle-mounted access control component;
the authentication element and the access control component are synchronized so that the authentication element knows the time at which the vehicle-mounted access control component emits pulses;
during a time period in which the vehicle-mounted access control component does not emit any pulses, a null measurement is performed by a device for performing null measurement determining an interference level of an interference transmitter which is present in the same frequency range;
based on a determined interference level, the pulse is rejected, starting from a predetermined threshold value of the interference level, or if the determined interference level lies below the predetermined threshold value, a threshold value which is adapted to the determined interference level is determined in order to distinguish between an authentication element in the vehicle or on the outside of the vehicle, and the adapted threshold value is transmitted over the access authorization communications channel to the access control component by means of an authentication element locating means in order to be taken into account by the authentication element locating means during subsequent position-determining processes for the authentication element.

13. A method of operating a vehicle security system of the type in which a vehicle mounted access control component transmits pulses to an authentication element that is transportable by a vehicle operator, and generates a securing or releasing signal for at least one vehicle locking or operating component only upon receipt of a corresponding authentication signal from said authentication element, which authentication satisfies preset criteria, said method comprising:
a null period measuring device in said authentication element measuring an applied field strength at said authentication element during a null period in which said access control component does not transmit pulses;
determining an interference level based on the applied field strength determined by said null period measuring device during said null period; and
based on said determined interference level, either i) modifying said preset criteria or ii) suppressing transmission of said authentication signal by said authentication element.

14. The method according to claim 13, wherein:
if said determined interference signal does not exceed said value, a triggering threshold for detection of presence of said authentication element is adapted to said determined interference level.

15. A vehicle security system, comprising:
a vehicle mounted access control component; and
an authentication element that is transportable by a vehicle operator; wherein,
said access control component periodically transmits an interrogation signal for receipt by an authentication element that is within an operational range;
an authentication element that is within said operational range receives said interrogation signal, for transmitting a corresponding authentication signal in response thereto;
said access control component generates a signal for securing or releasing a vehicle access or operating component, only in response to receipt of an authentication signal that satisfies present criteria;
said authentication element includes a null period measuring device for measuring an applied field strength during a null period in which an interrogation signal is not being transmitted by said access control component; and
based on said applied field strength measured by said null period measuring device, either i) said preset criteria are modified, or ii) transmission of said authentication signal is suppressed.

16. The method according to claim 15, wherein:
if said determined interference signal does not exceed said value, a triggering threshold for detection of presence of said authentication element is adapted to said determined interference level.
